(19) United States
(12) Patent Application Publication
(10) Pub. No.: US 2006/0232984 A1
(43) Pub. Date: Oct. 19, 2006

(54) Compact fluorescent lamp fixture ventilation method and apparatus

(76) Inventors: Kory Schuknecht, Scottsdale, AZ (US); Dan Meadows, Paradise Valley, AZ (US); William E. Schrader, Fountain Hills, AZ (US); Michael G. Gross, Sacramento, CA (US); Michael J. Siminovitch, Woodland, CA (US); Erik Page, Winters, CA (US)

Correspondence Address: LAW OFFICES OF DOUGLAS W RUDY LLC;14614 NORTH KIERLAND BLVD, SUITE 300, SCOTTSDALE, AZ, 85254, US

(21) Appl. No.: 11/367,143

(22) Filed: Mar. 3, 2006

Related U.S. Application Data
(60) Provisional application No. 60/659,606, filed on Mar. 8, 2005.

(51) Int. Cl. F21V 29/00

(52) U.S. Cl. 362/373; 362/294; 362/345; 362/218

(57) ABSTRACT

Air flow management of a compact fluorescent lamp fixture is provided to cool the lamps. Lamp chamber ventilation is passive and/or active through the use of vents in the lamp chamber and/or the use of a fan to induce air flow. Ballast housing ventilation is also provided to manage temperatures inside ballast housings associated with lamp chambers of compact fluorescent lamp fixtures.

### RELATED APPLICATION

This application claims priority from Provisional Application No. 60/659,606, filed Mar. 8, 2005, herein incorporated by reference.

### BACKGROUND OF THE INVENTION

The devices presented here are directed to a compact fluorescent lamp (“CFL”) type lighting fixture that has improved cooling capability. The lighting fixture that is the subject of this invention is a sometimes referred to as a “CFL high bay fixture,” a luminaire, a CFL fixture, or the like. Such a CFL fixture will have a compact fluorescent lamp as the light source and will often have a ballast housing, appropriate ballasts, wiring, a controller as necessary, lamp support structure, lamps and a lamp chamber as major components of the fixture. Many of these CFL fixtures will have multiple compact fluorescent lamps mounted in a single fixture. Several embodiments of compact fluorescent lamp fixtures are shown in U.S. Pat. Re. 36,414, titled Lighting Apparatus, herein incorporated by reference. This patent also includes a reference to permitting the passage of heated air outwardly from the fixture, however there is no teaching in Pat. Re. 36,414 of the improved air flow management systems, the devices or the methods as invented by the inventors of this invention and as taught in this specification. The invention herein is directed to air flow management in the ballast housing and in the lamp chamber, either independently or the ballast housing and the lamp chamber together, of the fixture. Improved air flow management apparatus and methods are used to improve the light output of a compact fluorescent lamp fixture through various techniques not taught by or known in the compact fluorescent lighting industry. Using the heat control and air flow management measures set forth in this disclosure the lumen output of a compact fluorescent lamp lighting fixture can be improved over CFL fixtures available today and to the point of maximizing a lighting fixtures performance over a range of ambient and local temperature gradients.

Compact fluorescent lamp high bay fixtures compete with high wattage, high output High Intensity Discharge (“HID”) fixtures. One type of competing HID fixture is a metal halide high bay fixture. High and low pressure sodium fixtures, as well as other types of fixtures also compete with compact fluorescent lamp fixtures. Compact fluorescent lamp fixtures do not run optimally at high temperatures and thus are at a competitive disadvantage to metal halide units and some of the other HID fixtures. CFL fixtures create a significant amount of heat that may be constrained in the lamp chamber, reflector, refractor or dome of the luminaire resulting in the production of less lumen output, than would be optimal or is theoretically available from a given lamp. Several articles pertaining to compact fluorescent lamp fixtures as compared to HID fixtures are included herein in Appendix 1. These include: “Independent Report Prepared by Ian Lewin, Ph.D. FIES”; “Independent Report Prepared by Russell W. Blades C.E.T.”; “Ally Corner, Sportlite Upgrades at Abbott Laboratories and Oceanside Ice Arena,” Green Light Update, January 1993, United States Environmental Protection Agency, Washington, D.C., each of these is herein incorporated by reference.

There has been a long felt need to provide a device or method of air flow that will allow CFL fixtures to run cooler. Running a compact fluorescent lamp in a designed temperature range, normally a range that is cooler than is found in some CFL fixtures, will maximize the light output of the lamp. It has also been found through empirical studies that running a CFL fixture too cool with denigrate lamp output.

The need to run CFL fixtures in a cooler, but controlled temperature range, had not been adequately addressed until now as there have been compact fluorescent lamps that were specially manufactured to be heat tolerant. On another front the manufacturers of compact fluorescent lamps have increased the wattage of the lamps in order to become more competitive with the HID fixtures and with this increase of wattage compact fluorescent lamp temperatures inside a lamp chamber have increased. Also, there is a trend to increase the aggregate or cumulative wattage output of CFL fixtures either by increasing the number of lamps in each fixture or by increasing the cumulative wattage of CFL fixtures. The floor for the need to control lamp temperatures in a lamp chamber is in the vicinity of two hundred watts/fixture, assuming lamp chambers and ballasts of the type and size that are popular today.

The devices and methods disclosed herein have been found through design refinement and empirical testing to lower the temperature in a CFL high bay fixture. This temperature reduction will help maximize the lumen output of such a fixture. Air flow control devices and methods disclosed herein result in a decrease in temperature in the vicinity of the compact fluorescent lamps. This temperature reduction has been shown to effectively increase the lumen output of a CFL luminaire by up to twenty or thirty percent, or even more.

This invention is directed to devices and methods for venting, either actively or passively, the lamp chamber of a light fixture that uses multiple compact fluorescent lamps. It is primarily, but not exclusively, directed at CFL fixtures where the sum of wattage of all of the lamps in the fixture exceeds 200 watts.

Presented are various methods for venting the lamp chamber, either actively or passively. The lamp chamber can be vented with apertures in the walls of the lamp chamber. Another embodiment is to vent the lamp chamber with an aperture in the top or base end of the lamp chamber. This aperture is arranged so that heat from the lamp chamber is not transmitted into the ballast housing in one embodiment. In other embodiments the aperture in the top of the lamp chamber does transmit heated air into the ballast chamber.

The devices set forth herein may produce thirty percent or more extra light (either down light in a down light only fixture or down light and up light in a fixture designed to up light as well as down light) from a standard compact fluorescent lamp high bay fixture. The invention is designed to cool the compact fluorescent lamps and, in some iterations or embodiment disclosed, the ballasts driving the lamps.

### SUMMARY OF THE INVENTION

The device set forth herein is a luminaire that has active and/or passive cooling inducing elements. Multiple embodiments of the invention directed to controlling air flow through the luminaire, are presented. In one embodiment air flow is controlled by providing a communication port from the top of the lamp chamber of the luminaire to and through the associated ballast housing. In another embodiment air management is effected by vents or apertures in the lamp chamber itself. Passive air management and inducted air management embodiments are provided that each, in a different environment, may passively or actively control air movement at the internal and external boundaries of a luminaire.

Thus, it is an object of the invention to affect the flow of air through a luminaire.

It is also an object of the invention to remove heat from the lamp chamber of a CFL fixture by providing active and/or passive air flow inducing elements.

It is also an object of the invention to vent a the lamp chamber of a compact fluorescent lamp fixture either actively or passively through the use of apertures in the walls of the lamp chamber.

Another object is to vent the lamp chamber with an aperture in the top or base end of the lamp chamber so that heat from the lamp chamber is not transmitted into the ballast housing of the compact fluorescent lamp fixture.

A further object of the invention is to vent the lamp chamber with an aperture in the top of the lamp chamber that will transmit heated air into the ballast chamber of the compact fluorescent lamp fixture.

It is also an object of the invention to remove heat proximate compact fluorescent lamps in a luminaire.

It is another object of the invention to passively control air flow in a compact fluorescent lamp luminaire.

Another object of the invention is to actively control the flow of air in a compact fluorescent luminaire.

Furthermore it had been found advantageous to reduce the temperature proximate a compact fluorescent lamp of a luminaire by passively and/or actively controlling the air proximate the compact fluorescent lamp.

Another advantage of reducing the temperature surrounding a compact fluorescent lamp of a luminaire is that the light output from the compact fluorescent lamp can be increased with controlled air flow around the lamp and in a lamp chamber of the luminaire.

Another advantage of the invention is that lamp output is controlled through selective air management such that lamp output does not decline through overcooling.

In one embodiment a ballast housing or ballast chamber of the luminaire, which includes a lamp chamber supported to the bottom portion of the ballast housing, is provided with a passive cooling vent in the base of the ballast housing. The ballast housing includes ports in the walls and/or in the lid of the ballast housing to allow heated air to escape from the interior of the ballast housing and lamp chamber of the luminaire.

The above summary does not include an exhaustive list of all aspects of the present invention. Indeed, the inventors contemplate that their invention includes all systems and methods that can be practiced from all suitable combinations of the various aspects summarized above, as well as those disclosed in the detailed description below and particularly pointed out in the claims filed with the application or subsequently added or amended. Such combinations have particular advantages not specifically recited in the above summary.

The preferred embodiments of the invention presented here are described below in the specification and shown in the figures. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning. In particular, most words commonly have a generic meaning. If we intend to limit or otherwise narrow the generic meaning, we will use specific descriptive adjectives to do so. Absent the use of special adjectives, it is our intent that the terms in this specification and claims be given their broadest possible, generic meaning.

Likewise, the use of the words “function,” “means,” or “step” in the specification or claims is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

### BRIEF DESCRIPTION OF THE DRAWINGS

Various embodiments of the present invention are described below with reference to the figures wherein like designations denote like elements when possible. Multiple lead lines and numbers may be minimized and a reasonable understanding that similar parts/elements not specifically identified with a lead line are similar is expected.

FIG. 1 is a representational line drawing of a section of a luminaire having passive cooling vents;

FIG. 2 is a representational line drawing of a section of a luminaire having a passive cooling chimney;

FIG. 3 is a representative line drawing of a section of a luminaire having a temperature responsive fan;

FIG. 4 is a representative line drawing of a section of a luminaire having a temperature controlled fan and a chimney;

FIG. 5 is a representative line drawing of a section of a luminaire having a passive cooling vent;

FIG. 6 is a representational line drawing of a section of a luminaire having passive air management incorporating a venturi;

FIG. 7 is a representational line drawing of a section of a luminaire having lamp sockets mounted to the housing element;

FIG. 8 is a representational line drawing of a section of the top of a luminaire ballast chamber, the top having vent holes;

FIG. 9 is a representational line drawing of a section of the top of a luminaire showing support beams for attaching a mounting element;

FIG. 10 is a representative line drawing of a section of a luminaire having supports for a mounting element;

FIG. 11 is a luminaire having multiple air management vents in a housing;

FIG. 12 is a luminaire having air flow management vents near the top of the luminaire lamp chamber;

FIG. 13 is a view of the luminaire shown in FIG. 12 showing horizontal apertures in the top of the lamp chamber;

FIG. 14 is a view of the luminaire shown in FIG. 12 showing apertures in the top of the housing;

FIG. 15 is a view of the ballast housing of a luminaire with the top opened showing a chimney;

FIG. 16 is a view of a luminaire from the open end of the lamp chamber having lamp sockets attached to the housing;

FIG. 17 is a view of a luminaire showing a ring;

FIG. 18 is a view of a lamp chamber and a metallic ring out of position on the lamp chamber;

FIG. 19 is a view of an alternative ballast housing with the top flipped open;

FIG. 20 is a view of a lamp chamber having a plurality of short tubes;

FIG. 21 is a representational line drawing simulating a sectioned view of a CFL fixture with an interior metal ring;

FIG. 22 is a representational line drawing simulating a sectioned view of a CFL fixture showing a reflected light path;

FIG. 23 is a representational line drawing simulating a sectioned view of a CFL fixture having an exterior ring element;

FIG. 24 is a representational line drawing simulating a sectioned view of a CFL fixture having air flow improving small tubes appended to the lamp chamber of the fixture;

FIG. 25 is a view of a small tube used in the embodiment shown in FIG. 24;

### DESCRIPTION OF PREFERRED EXEMPLARY EMBODIMENTS

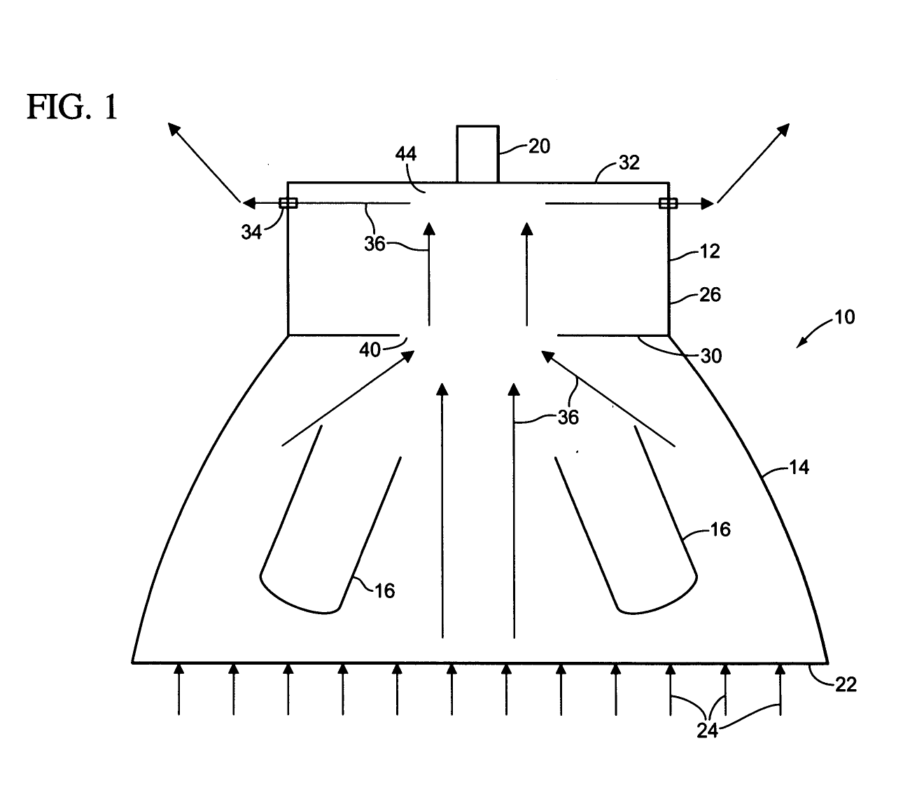

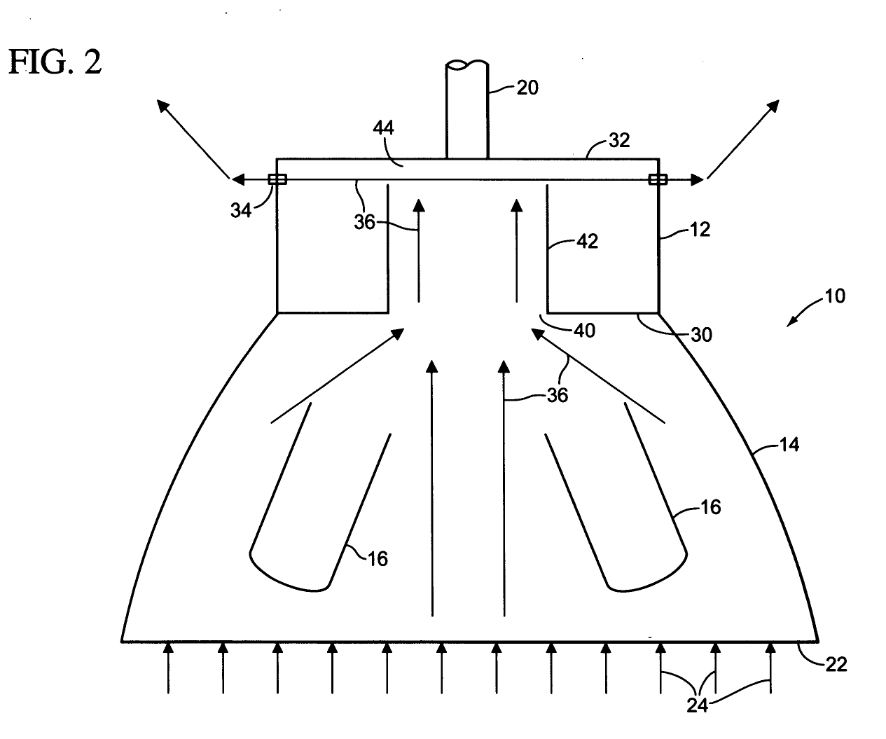

FIG. 1 presents a representational line sketch, in a sectioned view of an embodiment of the invention. In this embodiment a CFL fixture, generally 10, includes numerous components including a housing 12, a lamp chamber 14, also known as a reflector or dome, and a set of compact fluorescent lamps such as 16. This fixture will be supported in its installed environment by a mounting element 20. The mounting element can be a hook, a pendant style support, or a pipe or tube extending from the top of the housing, each of which are known structures to mount a compact fluorescent fixture. FIGS. 1 and 2 show mounting elements 20 that are different but are meant to be representative of the concept that any type of mounting element can be used as dictated by the mounting requirement.

The lamp chamber 14 is open at the bottom end 22 thereof. Light will be directed out the bottom of the lamp chamber in one embodiment. In other embodiments light will be directed not only out the bottom of the lamp chamber, but, depending on the configuration of the lamp chamber, light may be directed through the lamp chamber, if it is a light transmissive lamp chamber, out the sides or top of the lamp chamber if apertures are provided in the lamp chamber or even through a gap between the lamp chamber and the housing 12. Air flow as represented by the arrows such as 24 toward the bottom of FIG. 1, can flow into the lamp chamber 14.

The housing 12 may be used as a ballast housing, also known as a “ballast chamber.” In one embodiment of the invention a plurality of ballasts are mounted inside the housing. This is shown in embodiments used in many contemporary CFL fixtures, such as the Sportlite LX800-Series of CFL fixtures, a representative model being the Starliter, sold by Sportlite, Inc., as shown on catalog sheet LX800-Series, Starliter, attached hereto with other Sportlite product catalog sheets, all of which are incorporated herein by reference. These double sided catalog pages are attached in Appendix 1. Also included in Appendix 1 are two double sided catalog pages titled “Luminaires” and “Starliter Luminaries.”

There are also embodiments of CFL fixtures where ballasts are remotely located. These remote ballast fixtures may also benefit from the air flow and cooling elements provided in the lamp chambers and mounting assembles as discussed in this specification.

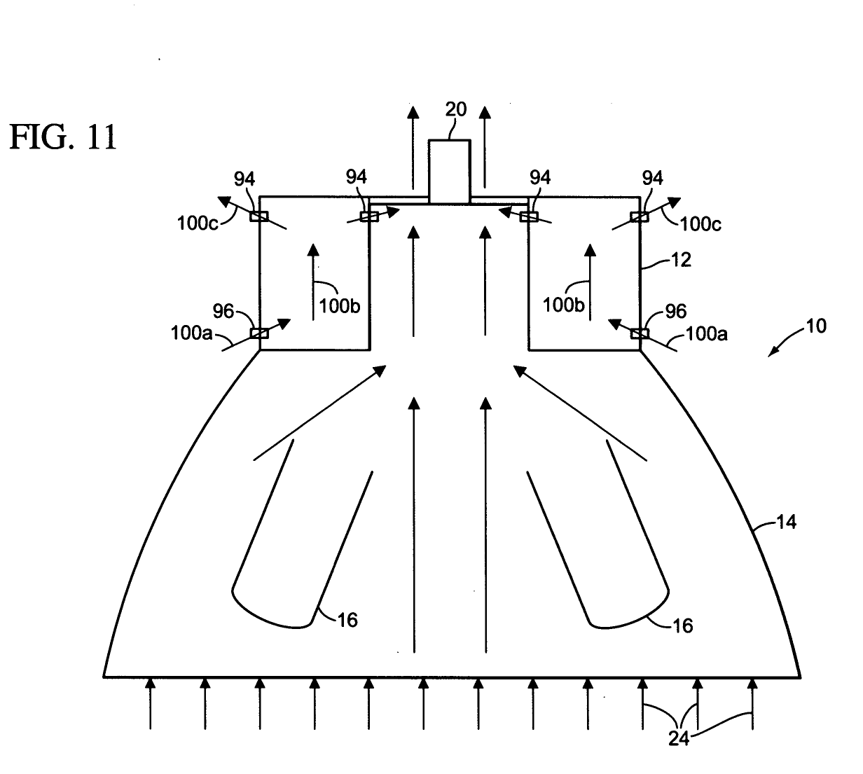

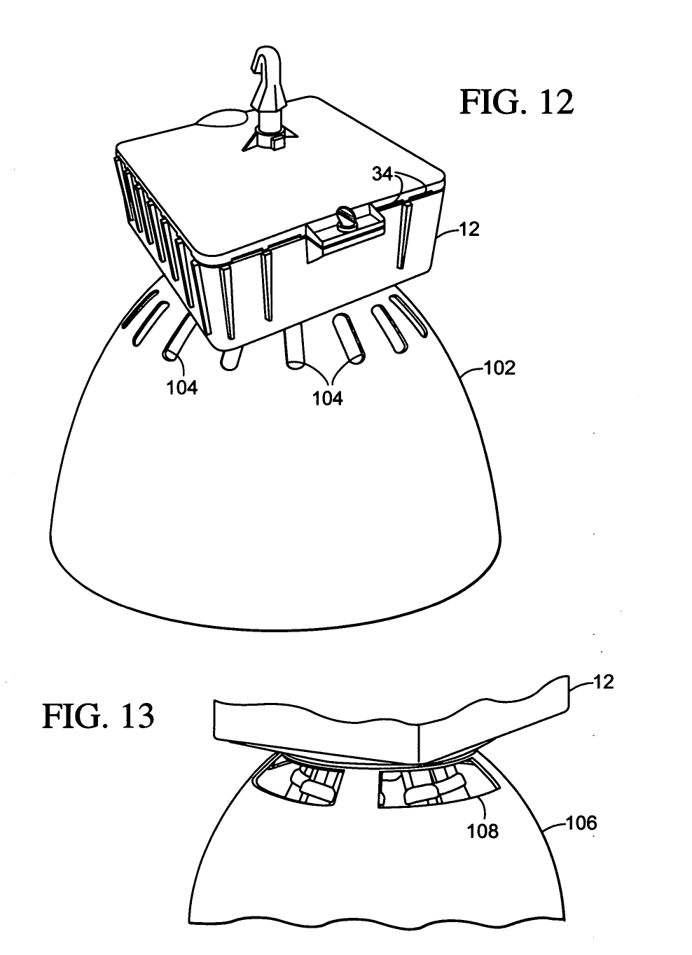

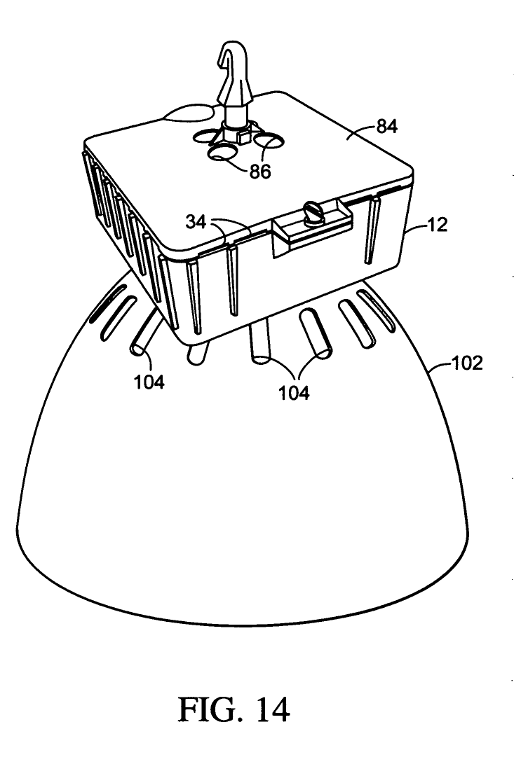

The ballast housing 12 is generally an enclosure having sidewall 26. The sidewall 26 will extend from a base 30 to a top of the housing 32. The top of the housing may be removable to provide access to the interior of the housing. In the embodiment shown in FIG. 1 there is a ventilation port represented as port 34, or more than one ventilation port located on the housing. One location for the ventilation port is at the upper terminus of the housing wall. It can be just below the top of the housing. See, for instance, FIGS. 12 and 14.

In this CFL fixture embodiment, as well as in all of the fixture embodiments presented herein, it is presumed that the fixtures will be supplied with a source of electrical energy to energize the lamps. The ballasts will be in the circuit and will control the compact fluorescent lamps in the well known manner of operating such CFL fixtures. The power source, the ballast, the method of supporting the fixture are well known elements and a person of skill in the art will be familiar with the general operation of such CFL fixtures, particularly high bay fixtures that use a plurality of compact fluorescent lamps such as the Sportlite LX800 series of CFL fixtures. What is presented herein is a method of increasing the light output and fixture performance by effecting the air flow into, through and out of a CFL fixture.

FIG. 2 is similar to FIG. 1. In this embodiment a chimney 42 is placed in the housing 12. The chimney 42 directs the flow of air, as represented by lines such as 36, from the interior of the lamp chamber 14 through the passive cooling vent 40 formed in the base of the housing 12, and to the upper zone 44 of the housing 12. Air flow in this upper zone, also represented by air flow pattern indicators such as 36, will flow toward and out the ventilation ports 34 of the housing 12.

In this embodiment air flow will enter the CFL fixture generally 10 from the open end 22 of the lamp chamber as shown by flow lines such as 24. The air flow will flow around and past the lamps 16 and through the housing 12 as directed by the chimney 42. The air flow will then find its way out of the housing through the ventilation ports such as 34. Thus part of the method of cooling or providing better air flow through the CFL fixture entails the method of providing a housing, providing a ventilation port or ports in the housing, providing a passive cooling vent in the base or bottom of the housing, providing a chimney in the housing, the chimney aligned with the passive cooling vent in the base of the housing and terminating at an upper zone of the housing, whereby air flow is conducted through the CFL fixture from the opening of the lamp chamber, past the lamps, through the passive cooling vent, through the chimney, into the upper zone of the housing and subsequently through the ventilation port or ports of the housing.

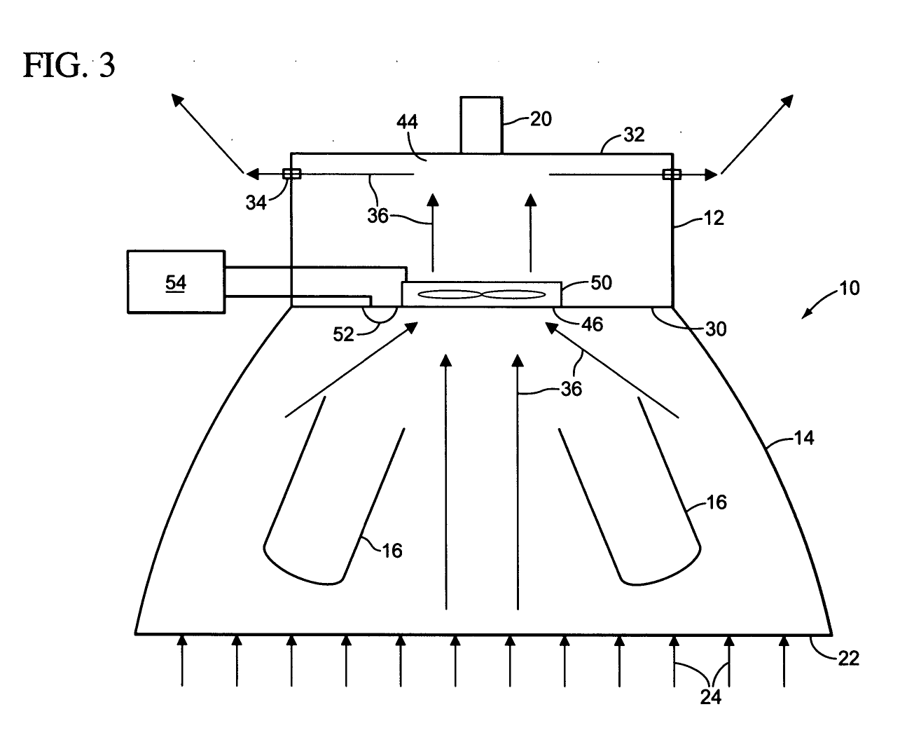

FIG. 3 presents an embodiment of the invention including a temperature controlled fan located proximate the housing base cooling aperture 46, that is, within the housing 12; or on the housing exterior, in essence below the housing base cooling aperture 46 in the housing. In this embodiment when the fan is turned on it will pull hot air from the lamp area into the ballast chamber. The continuous flow of air will cool the lamps and ballasts.

In this embodiment, where a fan is incorporated to effect the air flow through the luminaire, the fan will be located at the center of the ballast chamber above the compact fluorescent lamps. A hole the size of the fan, or sized to fit the installation requirements of the fan, in the ballast chamber area and the fan will be mounted over the hole. The fan could be mounted below or in the hole depending on the available mounting designed into the mounting location.

In one embodiment of an air management system where a fan is used, the fan 50 will be activated when a heat sensor 52 senses that the temperature in the fixture is at a threshold temperature. Both the fan 50 and the temperature sensor 52 will be supplied with power from module 54. Module 54 is a controller for the fan and may be an on-off device that will ether turn the fan 50 on or off responsive to the sensed temperature from the sensor 52 or it could be a multi-speed fan controller that would direct the fan 50 to run at a fan speed that will optimize the flow of air through the fixture to maximize the light output of the lamps such as 16. The module 54 may be supplied with power from the same source of power that is used to energize the lamps in the CFL fixture or from a separate circuit. In one embodiment, the fan will have a fence or cover over it to prevent hands or fingers from interfacing with the fan.

In one embodiment the fan will have a temperature sensor mounted in the lamp area next to or proximate the fan location. The sensor could also be located anywhere in the in the CFL fixture or luminaire. This is an optimal selection opportunity because the temperature sensor doesn't have to be on the compact fluorescent lamp itself. The sensor will take temperature readings and when the temperature reaches a designated temperature then the fan will turn on to cool the lamps and ballasts. The fan induced air flow provided will assist in the cooling. Through testing the inventors have related the optimal temperature range of the lamps in different locations on the fixture and can place the sensor in any location. When the optimum cooling temperature is reached then the sensor will alert or signal the fan to shut off. Both the sensor and the fan will be run off the AC power source that goes to the ballasts.

An alternative to the sensor responsive fan set forth above is to have a fan in the system that is not responsive to a sensor. In such an environment the fan could be sized to provide appropriate air flow as it ran continuously. It could be wired to come on with the compact fluorescent lamp fixture or could, as another embodiment, be wired to a timer to cycle the fan on or off while the fixture is on.

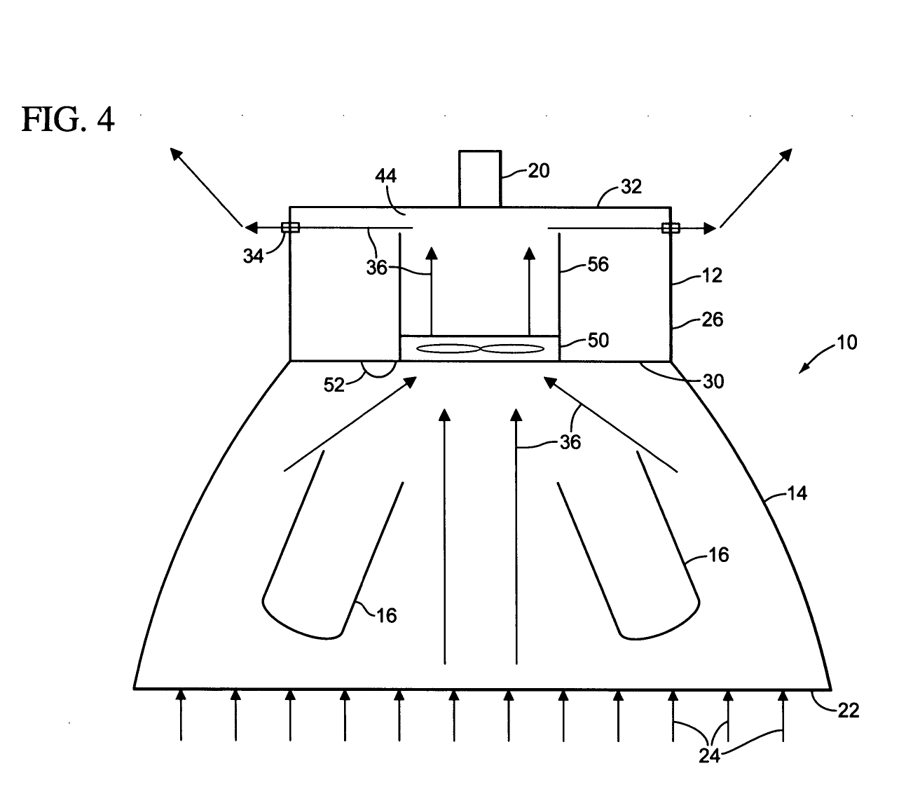

FIG. 4 is another embodiment of the invention. In this embodiment elements from FIGS. 1, 2 and 3 are used. This device has the fan 50 and heat sensor 52 from the embodiment shown in FIG. 3. The power source to the fan and sensor are left off of the figure but would be wired in a normal way such that the fan and sensor receive power and that the sensor controls the fan in a known way.

In this figure, FIG. 4, a chimney 56 is positioned in line with the fan 50. The fan is positioned over the housing base cooling aperture. An alternative location for the fan is below the housing base aperture. Other alternatives are also possible such as mounting the fan in the chimney, mounting the fan anywhere in the housing, mountin the fan outside the housing, or mounting the fan in the lamp chamber.

The chimney 56 will direct the air flow from the fan to the upper zone of the housing. From this location at the end of the chimney the air flow will be directed by the top of the housing outwardly toward and through the ventilation port or ventilation ports such as 34.

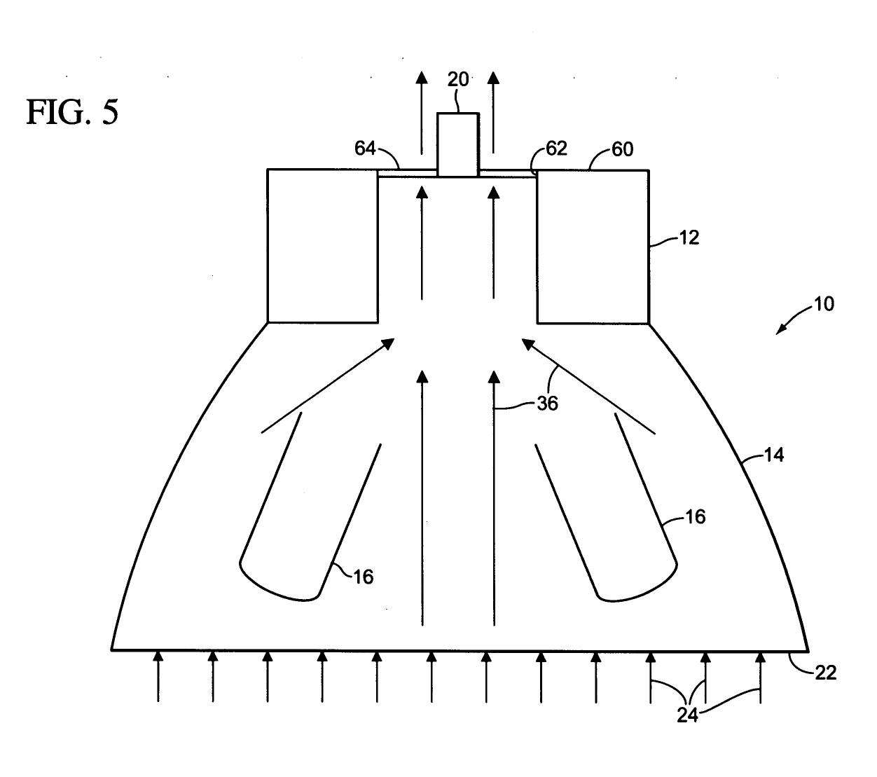

FIG. 5 shows a passive air flow improving embodiment of the invention. In this embodiment the top or cover 60 of the housing is provided with a central aperture 62 that, except for a mounting element support 64, is open to the atmosphere thus allowing an almost obstruction free path for air flow through the ballast housing 12. The mounting element support 64, which provides a mounting location for the hanger mounting element 20, may be a single transverse band extending from one side of the central aperture to the other. Other embodiments are also possible, for instance, the mounting element support can be a cross layout crossing the opening in two directions leaving four open spaces, a three legged element dividing the opening into three quadrants, or any reasonable variation that will support the mounting element and still leave an opening for air flow through the top of the housing. Furthermore, the mounting element support can be cast into the housing cover 60 rather than being a separate fabrication attached to the housing cover.

The housing in this, as well as in several following embodiments, can be thought of as being similar in shape to a ring torus, a toroidal shape, or a toroid. Normally such shapes have curved surfaces while the device shown in various figures herein show the housing with generally rectangular cross sectional shapes. Thinking of the housing as a torus helps to convey the general idea of what the housing shape is, that is in one embodiment, a generally rectangular box having a tube through the box from and through the bottom of the box to and through the top of the box. If the housing is not a generally rectangular box but is an alternative shape structure, the a tube would similarly pass through the structure from and through the bottom of the structure to and through the top of the structure.

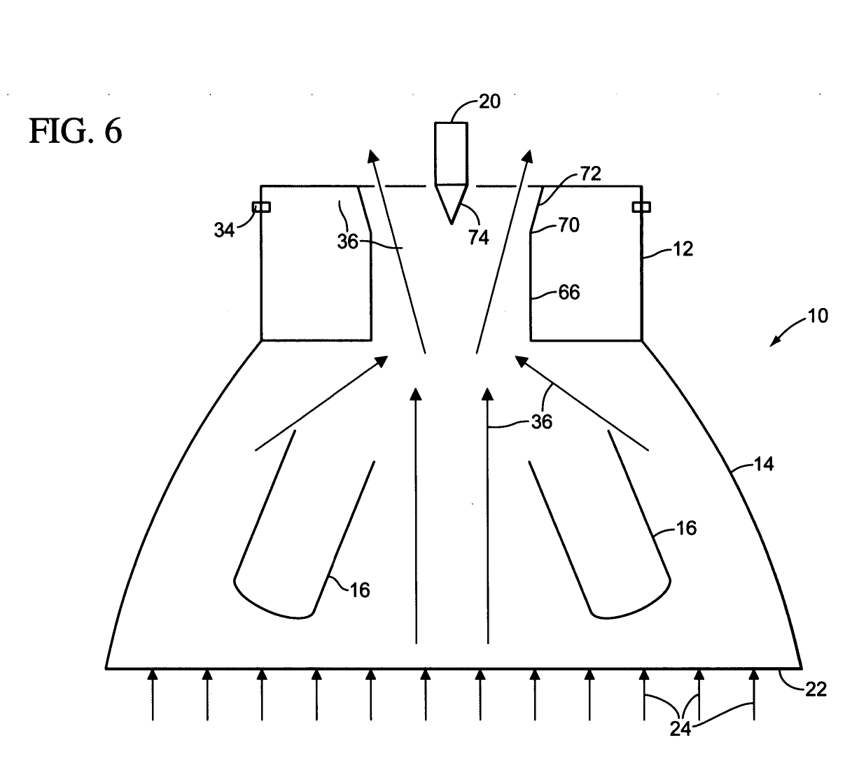

FIG. 6 is an embodiment that includes a venturi effect chimney. This embodiment incorporates a modified housing 12 with a modified chimney 66. This modified chimney incorporates a radius transition location 70 between the radius of the lower portion of the modified chimney and the increased radius section 72 of the modified chimney. This chimney modification will provide a venturi effect on the air flow flowing upwardly through the modified chimney 66. An flow deflection element 74 may be used to deflect air flow around the mounting element 20.

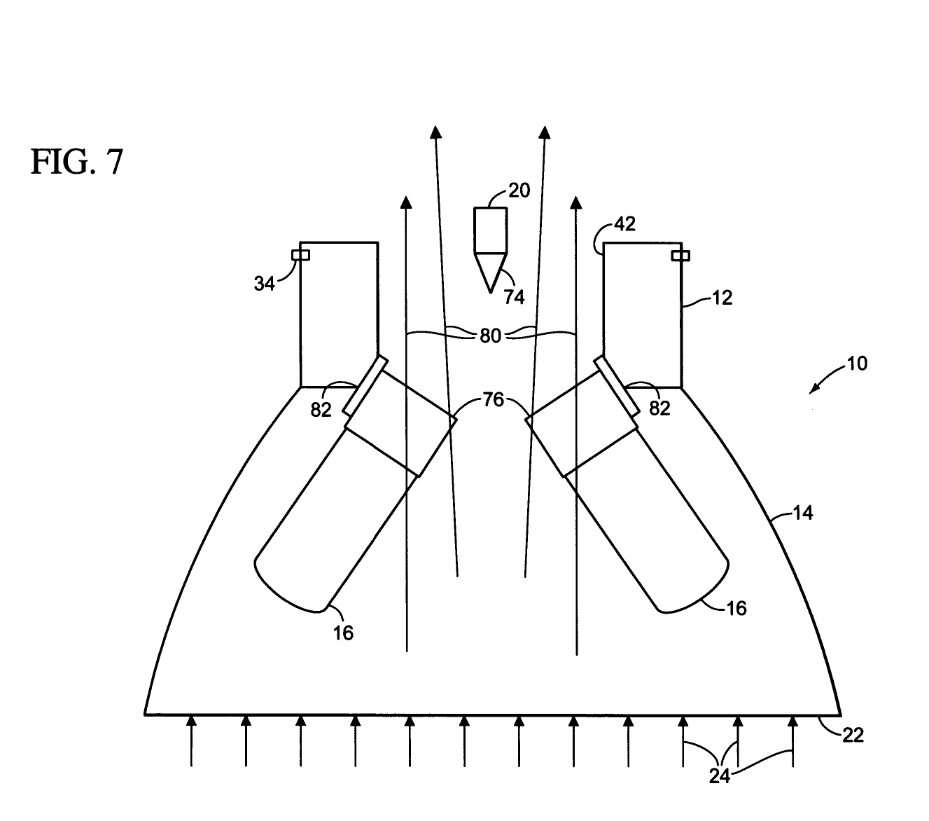

FIG. 7 is a representation of a CFL fixture that shows the mounting of lamp sockets 76 to the housing at the inboard and low section of the housing. In this embodiment the lamp sockets, two shown in the line drawing representation of a cross section of a CFL fixture, but any number of sockets can be used in a CFL fixture as long as there is room in the lamp chamber to accommodate them are mounted directly, rather than indirectly, to the housing 12. Typically there will be between four and eight lamps in a fixture but more or fewer lamps per fixture are contemplated for use in commercial or residential CFL fixtures.

In this embodiment wire routing from the torus shaped housing can go from the interior of the housing to the lamp sockets directly. In CFL fixtures with many lamps there is a large number of wires that have to be routed from the ballasts carried in the housing to the lamp sockets. This embodiment will simplify the wiring requirements by mounting the lamp sockets directly to the inboard corner areas, identified as area 82, of the housing 12. It also helps position the lamps, such as 16, more directly in the air flow stream directed upwardly through the chimney 42 as represented by the air flow representation lines such as 80.

FIG. 8 is a representation of the top view of a CFL fixture focusing on the rectangular housing lid or top 84. In this view, also a graphic representation or line view only, the top 84 is provided with a representation of a mounting element 20 and a plurality of small apertures such as 86. The small apertures 86 allow the escape of heated air from the interior of the housing not shown in this view. A group of eight lamp sockets are represented as being behind the top 84 in this view. These lamp sockets, such as 76, are shown to illustrate their positions relative to the small apertures 86. The size and number of small apertures 86 is determined by the need for air flow volume. Apertures of various dimensions are also contemplated by the inventors. It is expected that the total area needed to adequately cool a multi-lamp CFL fixture has to be at least one square inch. The more air flow volume needed the more small apertures can be provided. Thus one, two, three, four or more apertures can be formed in a representative top or lid.

In practice a top or lid 84 of the style shown in FIG. 8 can be used in the embodiments presented herein where there isn't a chimney such as is shown in FIGS. 1-4 to replace the top of the housing 32 shown in each of these figures. It is also expected that the style of top 84 shown in FIG. 8 can also be used on the embodiments shown in FIGS. 5-7 heretofore set forth.

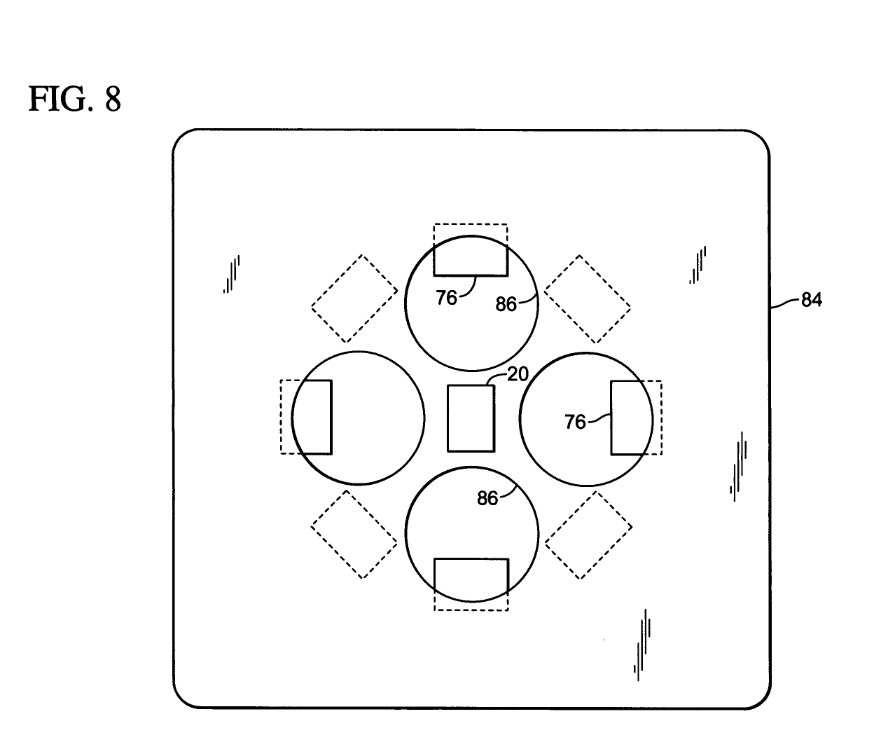

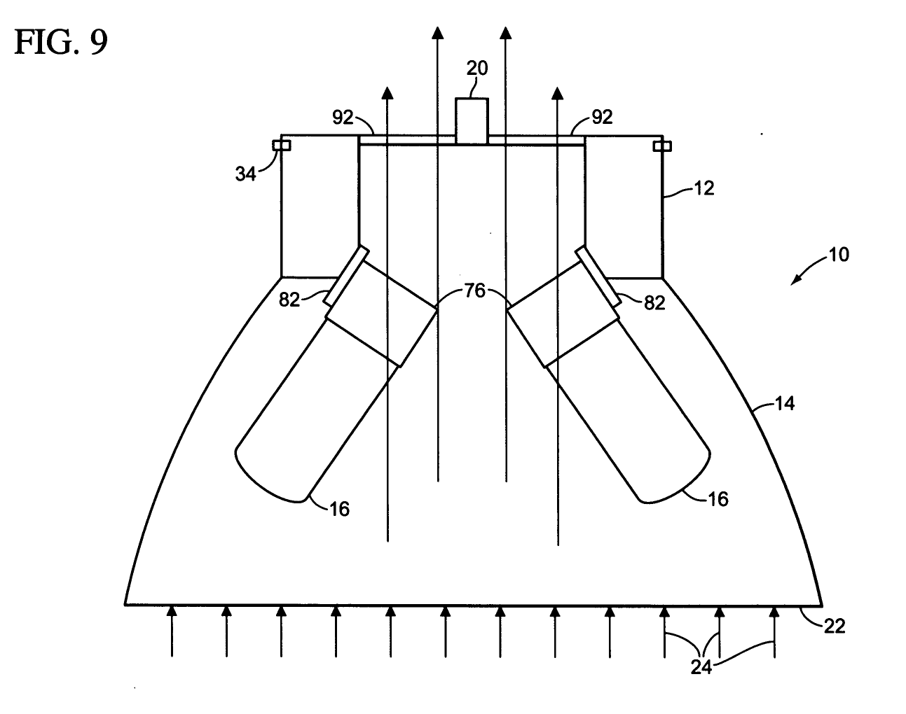

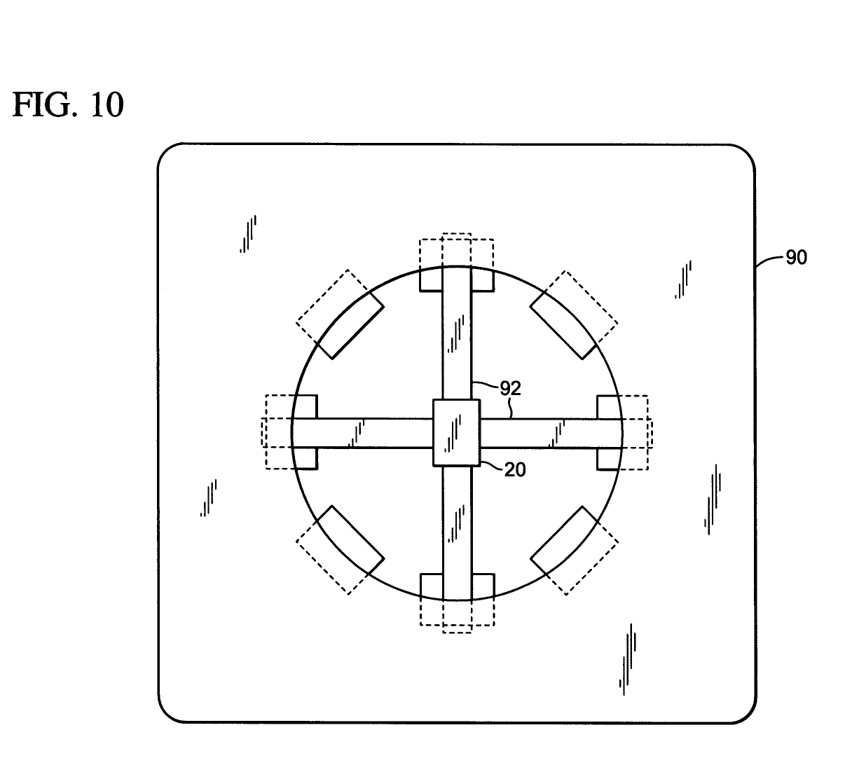

FIG. 9 is similar to FIG. 7 with the difference being the structure shown to hang the fixture. FIG. 10 is the top view of FIG. 9, showing an alternative top 90, and clearly shows support beams which are provided to support the mounting element 20. The open area between the support beams is the air flow passage allowing air flow from inside the housing to the environment outside the CFL fixture. This style of mounting element support is also shown in FIG. 5.

An alternative to the embodiment shown in FIG. 10 is also possible. This alternative embodiment would be a single transverse band extending from one side of the central aperture to the other side of the central aperture as discussed above. Other embodiments are also discussed above with regard to FIG. 5, such as the three legged element dividing the opening into three segments, or any reasonable variation that will support the mounting element and still leave an opening for air flow through the top of the housing.

FIG. 11 is a variation of the device set out in FIG. 5 with this embodiment including a set of upper side vents, four of the upper side vent set shown as 94, and a set of lower side vents, two of which are shown as 96. Air flow, represented by arrows 100 a-c, will be drawn into the housing 12 from the lower set 96 of vents and will be exhausted out the upper side vents 94. The air flow will be induced through convection through the housing as the ballasts inside the housing heat the housing up or through the use of a fan (not shown) in the housing 12.

FIG. 12 is a representation of an air flow inducing lamp chamber 102 shown mounted to a housing 12. The lamp chamber 102 is provided with a plurality of vertical vents such as 104 near the top of the lamp chamber. The vents are spaced apart and arranged around the top of the lamp chamber 102, sometimes referred to as a “dome,” to provide air flow out the vents and thus improve air flow through the lamp chamber. This will increase air flow around the lamps in the CFL fixture and reduce temperatures in the vicinity of the lamps. Reducing the temperature in this way will improve the light output of the CRL fixture. Vent size is not limited to a particular ratio of vent area to lamp chamber area and various ratios may be sufficiently effective to make venting the lamp chamber desirable. However it is known that vents of significant size are needed to make air flow management sufficient to deal with the heat generated by multi-lamp CFL fixtures that have aggregate wattage outputs of the higher levels now and in the future of CFL fixtures.

FIG. 13 is a representation of an air flow inducing lamp chamber 106 shown mounted to a housing 12. The lamp chamber 106 is provided with a plurality of horizontal vents such as 108 near the top of the lamp chamber. The vents are spaced apart and arranged around the top of the lamp chamber 106 to provide air flow out the vents and thus improve air flow through the lamp chamber. As shown in the embodiment set forth in FIG. 13 these vents are relatively large and comprise significant area at the top of the lamp chamber 106. Smaller vents, as well as larger horizontal vents are also contemplated.

FIG. 14 is an embodiment of the invention incorporating the housing 12 configuration shown in FIG. 4, for instance. The housing 12 could alternatively be of the type where a chimney is provided from the bottom or the floor of the housing toward the top of the housing. In either case a significant aperture is provided in the bottom or floor of the housing 12 to assist in promoting air flow from the lamp chamber 102. In this embodiment the lamp chamber 102 is provided with vertical vents 104 as set forth in FIG. 12.

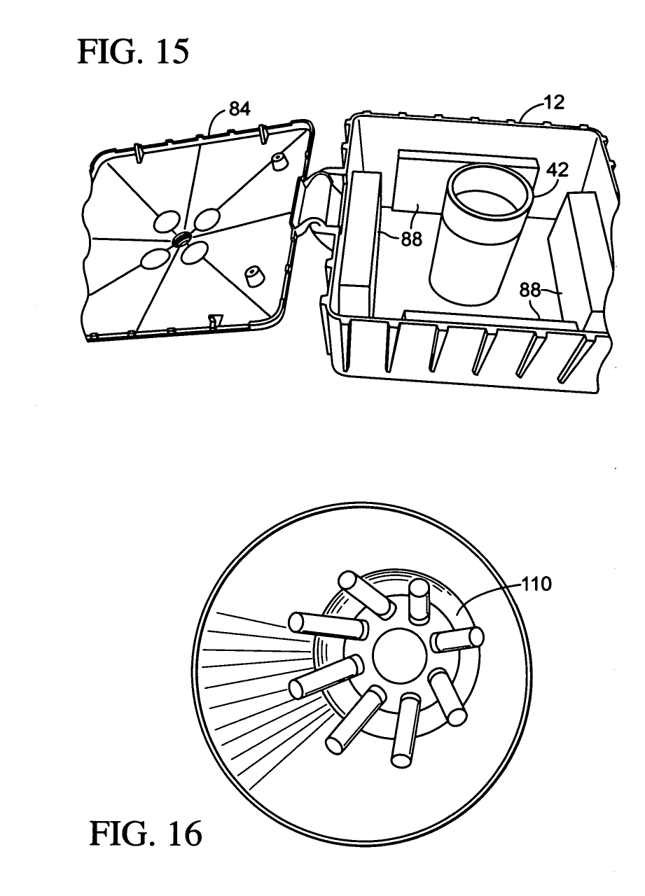

FIG. 15 is a view of the embodiment shown in FIG. 14 with the lid 84 “flipped open” revealing the chimney 42 in the housing 12. As is known in the field, ballasts such as 88 are placed around the interior perimeter of the housing. In this figure an alternative embodiment would be to make the top of the chimney out of a compliant material such as foam or deformable rubber. Thus when the lid is positioned over the main body of the ballast housing there will be a seal between the chimney and the inside of the lid. This will assist in preventing air flow in the chimney from getting into the housing outside the chimney. Another embodiment of the chimney lid interface is to have the chimney and the interior of the lid matched so that there is a good fit one-to-another.

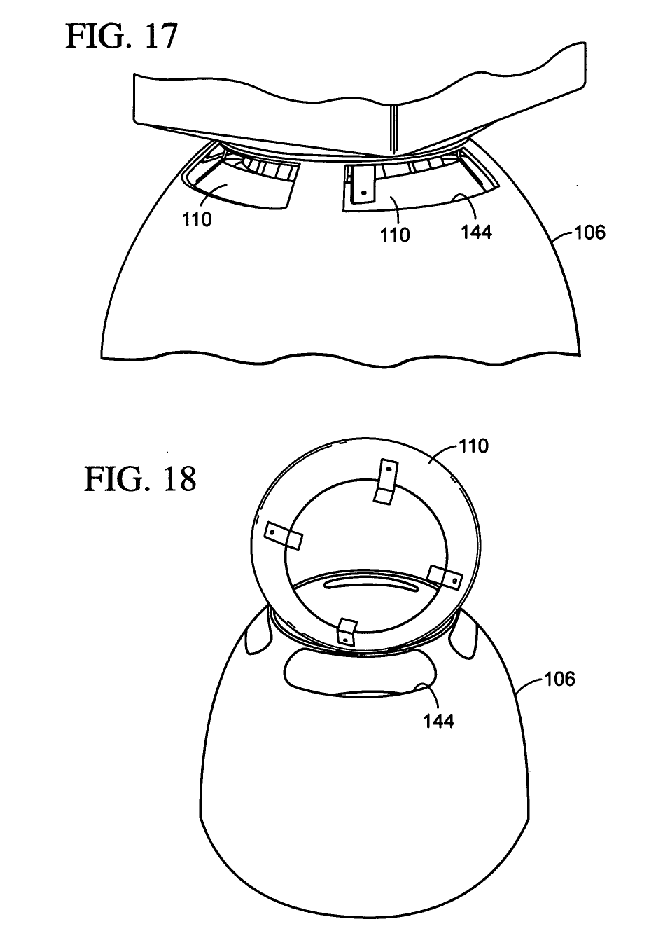

FIGS. 16-18 present a representation of an embodiment of the invention that includes a reflective piece 110. The purpose of the reflective piece 110 is to reflect light from the lamps in the lamp chamber toward the base of the lamp chamber, that portion at the bottom of the lamp chamber where most, if not all of the light in a down light fixture, is projected from, while not letting significant light to escape from the lamp chamber from the vertical or horizontal vents shown in FIGS. 12-14. The reflective piece is a ring of material, preferable a metal or plastic, having a reflective surface. It is usually mounted inside the lamp chamber, as shown in FIG. 17, standing off slightly from the surface of the lamp chamber. It stands off from the interior surface of lamp chamber to allow airflow behind it such that air flow is unimpeded in its path out of the interior of the lamp chamber through the vents in the lamp chamber. Since the principle of reflecting light away from the vents, whether they be vertical vents or horizontal vents, is the same the reflective piece need only be sized to cover the openings on either the vertical vents or on the horizontal vents.

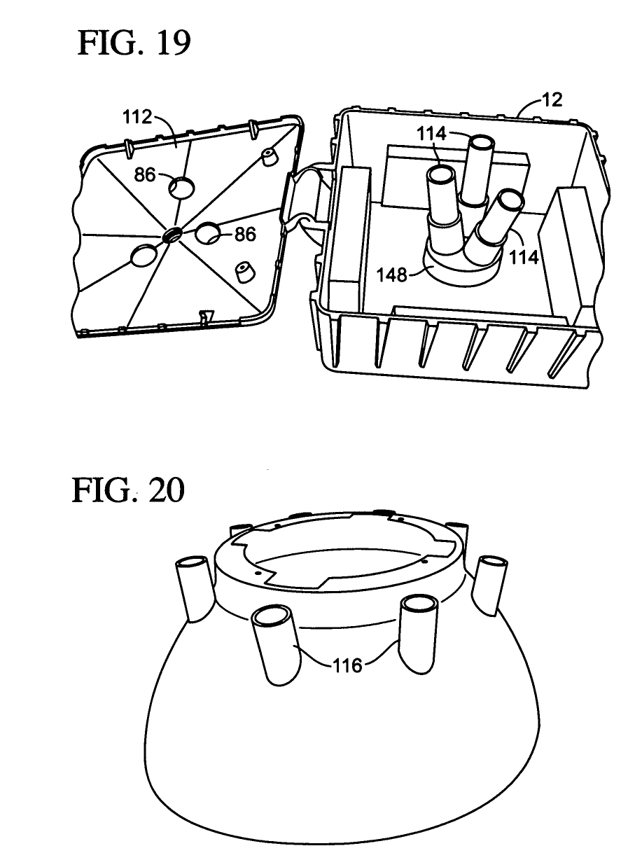

FIG. 19 is a representation of a housing 12 in which a lid 112, similar to the lid shown in FIG. 14, but having three small apertures 86 rather than four small apertures, has been flipped open. The inside of the housing shows a phalanx of multiple tubes, three shown in this embodiment although more or fewer are also possible. The three tubes, identified as 114, emanate from a plenum 148 aligned with an aperture in the bottom of the ballast housing. Each one of the three tubes will line up with one each of the small apertures such as 86. Airflow will then be able travel from the plenum 148 through the tubes and out the small apertures 86 in the lid 112. This arrangement is desirable as it allows heated air from the interior of the lamp chamber to pass through the ballast housing directly. The tubes allow the vent holes, such as 86 to be spaced apart and in locations more amenable to avoiding interference with structures either inside the housing 12 or on the lid 112. The tubes need not be straight nor do they have to each be the same length. They could incorporate different bends, lengths and diameters to fit into the structure provided by and allowed by the wiring, ballasts and other structures of the housing.

FIG. 20 shows a modified lamp chamber. The modification made to a standard lamp chamber is that a plurality of holes are provided in the upper area of the lamp chamber and these holes are connected to an equal plurality of short tubes such as two identified as 116. The short tubes may be angled such that light passing into the tube from the apertures in the upper area of the dome does not exit the end of the tube. The tubes are designed and positioned to allow air flow from the top of the lamp chamber, much like the vertical and horizontal vents described above, but also to trap at least some of the light before the light exits the short tubes 116. Some lighting situations require that there is little of no up-lighting and this embodiment meets that requirement.

The effectiveness of the short tubes can be enhanced by inserting baffles inside the tubes. This will further obstruct light from getting through the tubes but will allow heated air flow from the inside of the modified lamp chamber to escape from the lamp chamber.

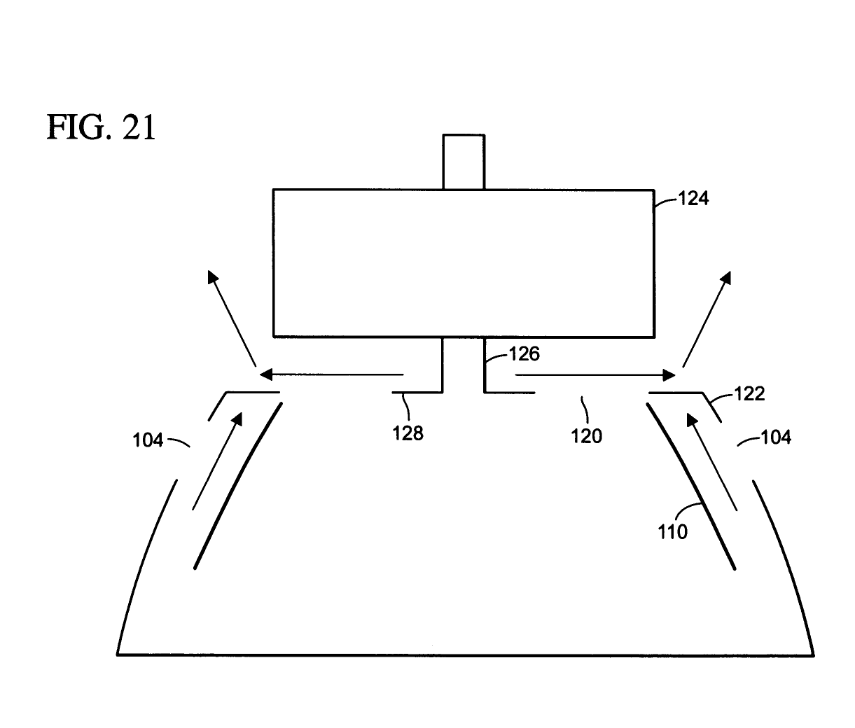

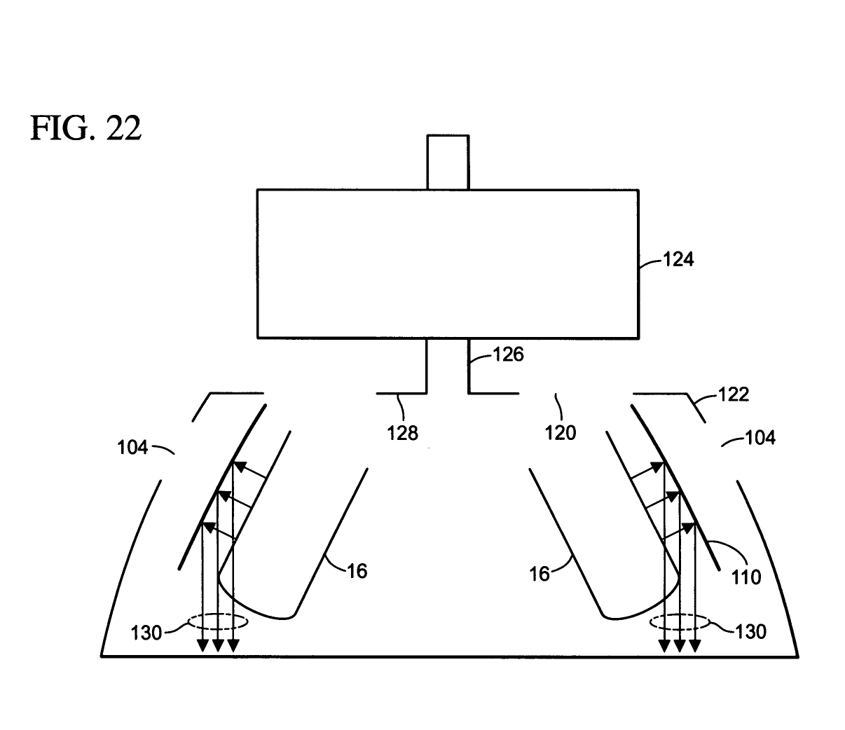

FIGS. 21 and 22 show a line representation of a CFL fixture. The two views are of the same embodiment however FIG. 21 shows the air flow through the fixture and FIG. 22 shows the possibility of reduced optical losses through the use of a reflector that reflects light out the large opening of the lamp chamber. The embodiment shown in FIGS. 21 and 22 is similar to the embodiment shown in FIG. 18. The vertical vents 104, are outboard of the reflective piece 110. The reflective piece can be a ring of material as shown or individual reflective pieces can be positioned inboard of the vertical vents 104. Since the reflective piece is mounted inboard from the interior surface of the lamp chamber it provides a channel for air flow to be directed out from the vents. In the embodiment shown in FIG. 21 there will be an opening, either a large aperture 120, or small apertures, that will allow heated air to exit the top of the lamp chamber. Also in the embodiment shown in FIGS. 21 and 22 the lamp chamber 122 is mounted to the housing 124 through a stand-off 126. The stand-off 126 is a connection between the housing 124 and the lamp chamber 122. The lamp chamber 122 will be configured to have a structural element, such as attachment plate 128, that is attached to the housing 124 through a connection such as the stand-off 126. In this configuration the lamp chamber 122 has air flow management that is independent of any air flow management in the housing 124.

FIG. 22 is the embodiment shown in FIG. 21 with the inclusion of representations of compact fluorescent lamps 16. The light path, as shown by lines such as 130, is emitted from the lamps 16 and reflected off the reflective piece 110. A portion of the reflected light is reflected downwardly as shown by the light path indicator lines.

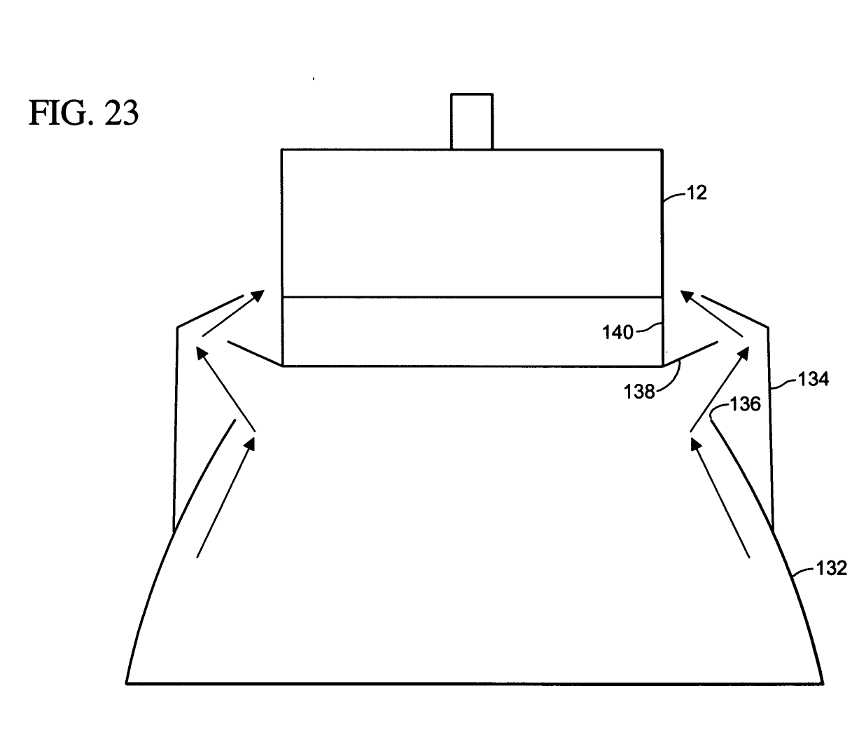

FIG. 23 is still another embodiment of the invention. In FIG. 23 there is an exterior collar 134 that is positioned over vents such as vent 136. The exterior collar is configured to allow the passage of heated air from the interior of the lamp chamber to the surrounding environment while trapping light to minimize up-lighting. Flange 138 is a component of the exterior collar 134 and is connected thereto. The gap to allow air flow, represented by the three arrows on each side of the drawing, out of the lamp chamber 132 is an aperture in the exterior collar 134. This aperture, or a multiple of apertures, can be a series of holes, vents, openings, or the like that allow air flow through them. In one embodiment the exterior collar is attached to the housing as shown by attachment structure 140. Other attachment options are available including, but not limited to, attaching the exterior collar to the lamp chamber or simple setting the exterior collar on the lamp chamber.

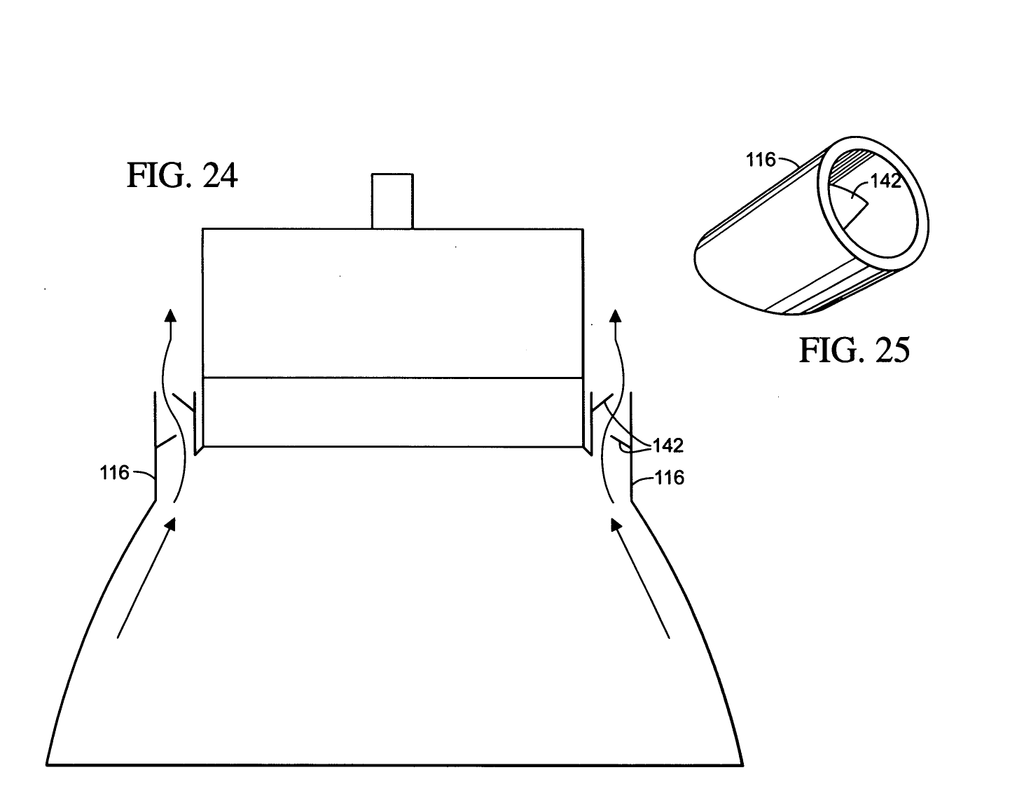

FIG. 24 is similar to FIG. 20 in that a plurality of small tubes such as 116 are arranged on the upper portion of the lamp chamber. In this embodiment the line drawing shows interior baffles 142 carried inside the tubes. The baffles will allow air flow out of the lamp chamber and through the tubes but will restrict the flow of light through the tubes and thus accomplish the goal of minimizing up-lighting while allowing cooling of the interior of the lamp chamber.

It should be pointed out that several of the embodiments presented herein are of utility in cooling the environment in aluminum lamp chambers or lamp chambers made of other non-transmissive material. For instance, FIG. 24 will accomplish this task as will the embodiments where a ring of reflective material is used inboard or outboard of the lamp chamber.

FIG. 25 is a view of one of the small tubes 116 showing a portion of the baffle 142 inside the small tube.

It has been disclosed herein that a compact fluorescent lamp luminaire has a housing and a compact fluorescent lamp chamber. The lamp chamber has a base end of first size and a light-emitting end of a second size larger than the first size. There is a center line extending from the center of the base end to the center of the light-emitting end of the lamp chamber. A lamp support is located within the lamp chamber at the base end for supporting a plurality of compact fluorescent lamps about the center line within the lamp chamber between the base end and the light-emitting end thereof. The lamp support includes at least two lamp support surfaces on the lamp support. They are on opposite sides of the lamp support. The lighting apparatus further comprises a ventilation passage extending from the lamp chamber to the housing. This ventilation passage originates at an aperture in the compact fluorescent lamp chamber. It has been found that if the aperture in the lamp chamber has an area greater than one square inch it is helpful in providing improved air management. The ventilation passage extends through an aperture in the housing.

In summary of the teaching set forth above there is provided a compact fluorescent lamp fixture comprising a housing having a base; a lamp chamber located adjacent the base of the housing; and a passage from the lamp chamber to the housing. The passage is defined by an aperture in the lamp chamber and an aperture in the base of the housing. The housing of this compact fluorescent lamp fixture may also have a ventilation aperture. Compact fluorescent lamps are, as expected, supported in the lamp chamber. The passage of the compact fluorescent fixture may be a flow directing chimney that defines at least a portion of the passage. The chimney length can be short, long or an indeterminate length depending on the design parameters of the fixture. The flow directing chimney may extend from the aperture in the lamp chamber to the aperture in the housing or go further into the lamp chamber or into the housing depending on the length of the chimney. In an additional embodiment the lamp chamber further comprises spaced apertures located on the lamp chamber. In one embodiment compact fluorescent lamps having wattage greater than forty watts per lamp are supported in the lamp chamber on the lamp support. In several of the compact fluorescent lamp fixture embodiments disclosed herein it is possible to have more than four lamps supported in the luminaire.

Furthermore, also in summary, there is provided a luminaire comprising a housing that contains compact fluorescent lamp ballasts; a ventilation passage formed in the housing; and a compact fluorescent lamp chamber in communication with the ventilation passage. The lamp chamber is connected to the housing and has a port in communication with the ventilation passage. The ventilation passage may be a chimney having a first end in communication with the compact fluorescent lamp chamber and a second end extending into the housing. In a related embodiment it is contemplated that the housing has ventilation ports formed in the housing to allow passage of air out of the housing.

In this luminaire embodiment the compact fluorescent lamp chamber has a light emitting end and a lamp support zone. It also has a first zone extending from the light emitting end of the compact fluorescent lamp chamber as well as a transition zone extending from the first zone to the lamp support zone. There may be spaced apart vents located in the compact fluorescent lamp chamber above the transition zone.

Air flow management, primarily the cooling of the lamp chamber and the ventilation of the ballast housing is accomplished through the acts of providing a ventilation passage from the lamp support to the housing. The passage has a flow directing chimney defining a portion of the passage from the lamp support to the housing. A further act is to provide a lamp chamber supported in place on the housing. This lamp chamber has a plurality of spaced apertures through its surface. Through these acts the efficiency of a compact fluorescent lamp luminaire is improved.

Not shown in the figures is a view of the testing facility used to find the optimal temperature ranges for compact fluorescent lamps highbay fixtures. The testing technique for the CFL highbay fixtures can be used with any combination of compact fluorescent lamps. Compact fluorescents lamps range from five watts to over one hundred twenty watts and the test technique will work for all of them. It is expected that compact fluorescents will be designed to operate at increased wattage and such wattage may be accommodated by the test facility and technique.

The testing technique, to find the ideal temperature of CFL high bay fixtures, is carried out in a room that is completely enclosed and will not get outside light or temperature interference. Easy access doors are provided to allow for changing of the fixtures and lamps. The room, of any reasonable size, is painted the same color on all the walls. A fixture, for hanging or supporting a CFL fixture, is provided inside the room to hang the CFL high bay fixture during the execution of the testing regime. In one embodiment a six foot high bar is provided to hang the fixture.

The testing procedure is directed to measuring a photometer sensor and the temperature measuring devices, such as thermocouples, at the same time and over a range of temperatures. From this data a correlation can be established for a specific fixture between the peak in light output (when lamps are neither too hot or too cold) to the temperature measurements at specific temperature measurement device locations. Once this correlation is established, designers and lamp evaluation technicians can be assured that the lamps are at their peak without even measuring the actual light output, just by making sure that the temperature measurement is in the right range.

The above methodology is adaptable to an active cooling scenario, where a flow inducing fan is used for instance. This test determined temperature measuring setting for peak output would be essentially the thermostat setting for the fan. Thus this setting could be used to signal the fan to turn on if the temperature is over the desired temperature range (“over temp”) or turn off if the temperature is below the desired temperature range (“under temp”).

Once a room is provided the testing procedure can be carried out. An illuminance meter, or something to measure light, and thermocouples, or something to measure temperature will be used in the testing procedure. Other heat measuring devices in addition to thermocouples, such as but not limited to thermal cameras and the like known to be used to measure temperature are contemplated by the inventors.

A step in the testing procedure is to find a location underneath the CFL fixture to measure light. This location is marked so that the location can be recorded and replicated as necessary. This location is the location that a test technician will measure light from. The actual location is not critical. Its location does not particularly matter but one location is to put it on the floor of the test room about six feet away from the CFL fixture. Its location should be consistent however. An appropriate location may be directly underneath the CFL fixture.

Temperature measuring devices such as thermocouples are optimally placed in at least four locations in the test room. More than four temperature measuring devices can be used in the room as well. One temperature measuring device is placed at the base of a lamp in the CFL fixture. This location is the location where a lamp manufacturer measures the lamp temperature when they show ideal lamp temperatures. A second temperature measuring device location is in the lamp area to determine the ambient lamp temperature. The lamp ambient temperature is directly related to the amount of lamp output from the CFL fixture.

It is desirable that when putting a temperature sensing device in its monitoring location, it is place the same location for every test so as to give consistent results.

In one test protocol an additional temperature measuring device to those mentioned above, is placed one inch away from the center of the ceiling of the lamp area inside the dome or lamp chamber. A fourth temperature measuring device is on a ballast of the CFL fixture. Manufacturers have temperature ratings that ballasts can optimally run at and it is desirable to be able to see how close to that temperature can be reached as testing and experimentation is being carried out.

In one embodiment another temperature measuring device is placed in the room away from the CFL fixture to sense ambient room temperature. Temperature measuring devices can also be placed on the ballasts, the lamps, or any other location that the testing authority deems appropriate.

What is claimed is:

1. A compact fluorescent lamp fixture comprising:
a housing having a base;
a lamp chamber located adjacent the base of the housing;
a passage from the lamp chamber to the housing, the passage defined by an aperture in the lamp chamber and an aperture in the base of the housing.

2. The compact fluorescent lamp fixture in accordance with claim 1 further comprising the housing having a ventilation aperture.

3. The compact fluorescent lamp fixture in accordance with claim 1 further comprising a compact fluorescent lamp supported in the lamp chamber.

4. The lighting fixture in accordance with claim 1 further comprising a flow directing chimney defining at least a portion of the passage.

5. The lighting fixture in accordance with claim 4 further comprising a flow directing chimney extending from the aperture in the lamp chamber to the aperture in the housing.

6. A luminaire comprising:
a housing, the housing containing compact fluorescent lamp ballasts;
a ventilation passage formed in the housing;
a compact fluorescent lamp chamber in communication with the ventilation passage, the lamp chamber connected to the housing and having a port in communication with the ventilation passage.

7. The luminaire in accordance with claim 6 wherein the ventilation passage comprises a chimney having a first end in communication with the compact fluorescent lamp chamber and a second end extending into the housing.

8. The luminaire in accordance with claim 6 wherein the housing further comprises ventilation ports formed therein.

9. The luminaire in accordance with claim 7 further comprising:
a compact fluorescent lamp chamber having a light emitting end and a lamp support zone;
a first zone extending from the light emitting end of the compact fluorescent lamp chamber;
a transition zone extending from the first zone to the lamp support zone; and
spaced apart vents located in the compact fluorescent lamp chamber above the transition zone.

10. A compact fluorescent lamp luminaire having a housing and a compact fluorescent lamp chamber, the lamp chamber having a base end of first size and a light-emitting end of a second size larger than the first size with a center line extending from the center of the base end to the center of the light-emitting end of the lamp chamber, a lamp support located within the lamp chamber at the base end thereof for supporting a plurality of compact fluorescent lamps substantially equally angularly displaced about the center line within the lamp chamber between the base end and the light-emitting end thereof, the lamp support including at least two lamp support surfaces on the lamp support on opposite sides thereof and angled toward the base end of the lamp chamber for causing compact fluorescent lamps supported thereby to extend outwardly at an angle from the center line, the lighting apparatus further comprising:
a ventilation passage extending from the lamp chamber to the housing, the ventilation passage originating at an aperture in the compact fluorescent lamp chamber and extending through an aperture in the housing.

11. The apparatus in accordance with claim 10 further comprising the aperture in the lamp chamber having an area greater than one square inch.

12. The apparatus in accordance with claim 10 wherein the lamp chamber further comprises spaced apertures located on the lamp chamber.

13. The luminaire in accordance with claim 10 wherein compact fluorescent lamps having wattage greater than forty watts per lamp are supported in the lamp chamber on the lamp support.

14. The invention in accordance with claim 13 wherein more than two lamps are supported in the luminaire.

15. The method of improving the efficiency of a compact fluorescent lamp luminaire wherein the luminaire includes a housing, a lamp support, and a lamp chamber comprising the acts of:
providing a ventilation passage from the lamp support to the housing, the passage having a flow directing chimney defining a portion of the passage from the lamp support to the housing;
providing a lamp chamber supported in place on the housing, the lamp chamber having a plurality of spaced apertures through the surface of the lamp chamber.

16. A compact fluorescent lamp fixture having multiple compact fluorescent lamps, the fixture comprising:
a housing having a base and having an aperture in the base of the housing,
a lamp chamber having a base end and a light emitting end,
a ventilation passage extending from the base end of the lamp chamber to and through the aperture in the base of the housing.

17. A method of testing compact fluorescent lamp fixtures in a test room comprising the acts of:
finding a location underneath the compact fluorescent fixture to measure light;
marking the location;
measuring light at the marked location.

18. The method set forth in claim 17 wherein the marked location is on the floor of the test room about six feet away from the compact fluorescent lamp fixture directly underneath the compact fluorescent fixture.

19. The method set forth in claim 18 further including the act of placing temperature measuring equipment in at least four locations in the test room with one temperature measuring piece of equipment located at the base of a lamp in the compact fluorescent lamp fixture and a second piece of temperature measuring equipment in the lamp area to determine ambient lamp temperature.

20. The method set forth in claim 19 wherein an additional piece of temperature measuring equipment is placed one inch away from the center of the ceiling of the lamp area inside the lamp chamber and another piece of temperature measuring equipment is on a ballast of the compact fluorescent fixture.

21. The method set forth in claim 20 wherein another piece of temperature measuring equipment is placed in the test room away from the compact fluorescent fixture to sense ambient room temperature.

22. The method set forth in claim 19 where the temperature measuring equipment is a thermocouple.

23. The method set forth in claim 19 where the temperature sensing equipment is a thermal camera.

24. A method of establishing a relationship between heat and light output of a compact fluorescent lamp fixture including the acts of:
sensing input in a photometer sensor;
sensing temperature with a temperature measuring device at the same time the input to the photometer sensor is sensing input;
sensing the temperature over a range of temperatures;
establishing a correlation for a specific fixture between the peak in light output to the temperature measurements at specific temperature measurement device locations.

25. A method of venting a lamp chamber of a compact fluorescent lamp fixture including the act of venting the lamp chamber through an aperture in a wall of the lamp chamber.

26. A method of venting a lamp chamber of a compact fluorescent lamp fixture, the lamp chamber having a top and the fixture including a ballast housing, including the act of providing an aperture in the top of the lamp chamber.

27. The method set forth in claim 26 further including the act of venting heated air out of the top of the lamp chamber without the heated air being transmitted into the ballast housing.

28. The method set forth in claim 26 further comprising the act of venting heated air out of the top of the lamp chamber and into the ballast housing.

29. The method set forth in claim 26 further comprising the act of venting heated air out of the top of the lamp chamber and directly through the ballast housing
